(19) United States
(12) Patent Application Publication
(10) Pub. No.: US 2007/0193690 A1
(43) Pub. Date: Aug. 23, 2007

(54) Paper feeder and laminating machine

(76) Inventors: Tadashi Kiyono, Saitama (JP); Ryo Yoshi-Oka, Kyoto (JP)

Correspondence Address: CLARK & BRODY, 1090 VERMONT AVENUE, NW, SUITE 250, WASHINGTON, DC, 20005, US

(21) Appl. No.: 11/441,033

(22) Filed: May 26, 2006

(30) Foreign Application Priority Data
Feb. 22, 2006 (JP) 2006-41598

(51) Int. Cl. B32B 37/00; B29C 65/00

(52) U.S. Cl. 156/538; 156/552

(57) ABSTRACT

A paper feeder provided with means (2) for aligning the direction of the top edge of a sheet of cut paper (4), the means (2) having a function to align the direction of the top edge of the cut paper (4) with a direction perpendicular to the direction along which the cut paper (4) proceeds, resultantly preventing the cut paper to proceed in an oblique direction, the foregoing means having an advantage that is simple in principle and structure, easy to handle and less expensive in the production cost.

### FIELD OF THE INVENTION

This invention relates to an improvement applicable to a paper feeder, the improvement being directed to correction of the direction in which a sheet of cut paper proceeds. More specifically, the improvement is directed to correction of the direction of the top edge of a sheet of cut paper having a shape of a quadrilateral that is fed by the paper feeder, toward a direction perpendicular to the direction in which the cut paper proceeds. Additionally, this invention relates to a laminating machine equipped with the foregoing improved paper feeder.

### BACKGROUND ART

A letter, a character, a geometrical figure or the like that is printed employing a printer, a copying machine or the like, generally has an ordinary or natural geometrical direction or orientation. A laminating machine that is designed to laminate plural sheets of cut paper having a shape of a quadrilateral, has an ordinary or natural geometrical direction or orientation, as well. Therefore, a sheet of cut paper having a shape of a quadrilateral is required to be fed in a specific direction corresponding to the foregoing ordinary or natural geometrical direction or orientation of the cut paper.

For the purpose to satisfy the foregoing requirement, a printer, a copying machine or the like and a laminating machine et al. are usually equipped with some type of paper guide or some type of automatic control system comprising a sensor to detect an extraordinary direction, if any, of a progress of the cut paper, more specifically an extraordinary direction, if any, of the top edge of the cut paper and a servomechanism for correction of the extraordinary direction of progress of the cut paper, more specifically of the extraordinary direction of the top edge of the cut paper, in response to a deviation detected by the foregoing sensor.

### DRAWBACKS REMOVED BY THIS INVENTION

Since the foregoing paper guide or the automatic control system requires a considerable amount of additional cost, however, development of a paper feeder provided with means for correction of the extraordinary direction, if any, of progress of the cut paper, more specifically the extraordinary direction of the top edge of the cut paper that is improved to be simple in principle and structure, easy to handle and less expensive in the production cost, has been required.

Accordingly, the first object of this invention is to provide a paper feeder provided with means for correction of an extraordinary direction, if any, of progress of the cut paper, more specifically of the top edge of a sheet of cut paper having a shape of a quadrilateral to be fed by the paper feeder, toward a direction perpendicular to the direction in which the cut paper proceeds, resultantly preventing the cut paper from proceeding in an extraordinary or oblique direction, the foregoing means having an advantage that is simple in principle and structure, easy to handle and less expensive in the production cost.

The second object of this invention is to provide a laminating machine provided with the foregoing improved paper feeder provided with the means for correction of an extraordinary direction, if any, of progress of cut paper, the correction mean having an advantage that is simple in principle and structure, easy to handle and less expensive in the production cost.

Unfortunately, the inventors of this invention do not know any prior arts for the foregoing improved paper feeder and for the improved laminating machine.

### SUMMARY OF THE INVENTION

The conceptual structure of a paper feeder of this invention is comprised of a tangible object e.g. a set of rollers having a function to wait unmoving until the cut paper reaches and start moving to cause the cut paper to proceed in response to arrival of the cut paper and means to feed cut paper toward the foregoing tangible object under a slackened position, resultantly realizing a function to cause the top edge of the cut paper parallel to the front edge of the foregoing tangible object.

In other words, the inventive concept of this invention can be restated as follows:

A sheet of cut paper is fed towards a gap of a set of rolls or the like that stays unmoving until the sheet of cut paper reaches.

It is important that the paper is a little slackened, at the time when the top edge thereof reaches the foregoing gap, because this is effective to make the direction of the top edge thereof automatically aligned with the direction of the gap.

After the direction of the top edge of the cut paper is aligned with the direction of the gap, the set of rolls starts moving, resultantly causing the cut paper to proceed keeping the direction of the top edge thereof in the direction perpendicular to the direction along which the cut paper proceeds.

As a result, the cut paper having a shape of a quadrilateral is allowed to proceed in the direction along the ordinary direction or orientation.

As was described earlier, the object of this invention is to remove a drawback wherein a paper feeder available in the prior art has possibility to feed a sheet of cut paper in an oblique direction with respect to the ordinary direction of the cut paper. Thus, the foregoing inventive concept successfully satisfies the object of this invention.

This patent application contains two inventions. The first aspect is directed to a paper feeder and the second aspect is directed to a laminating machine provided with the improved paper feeder.

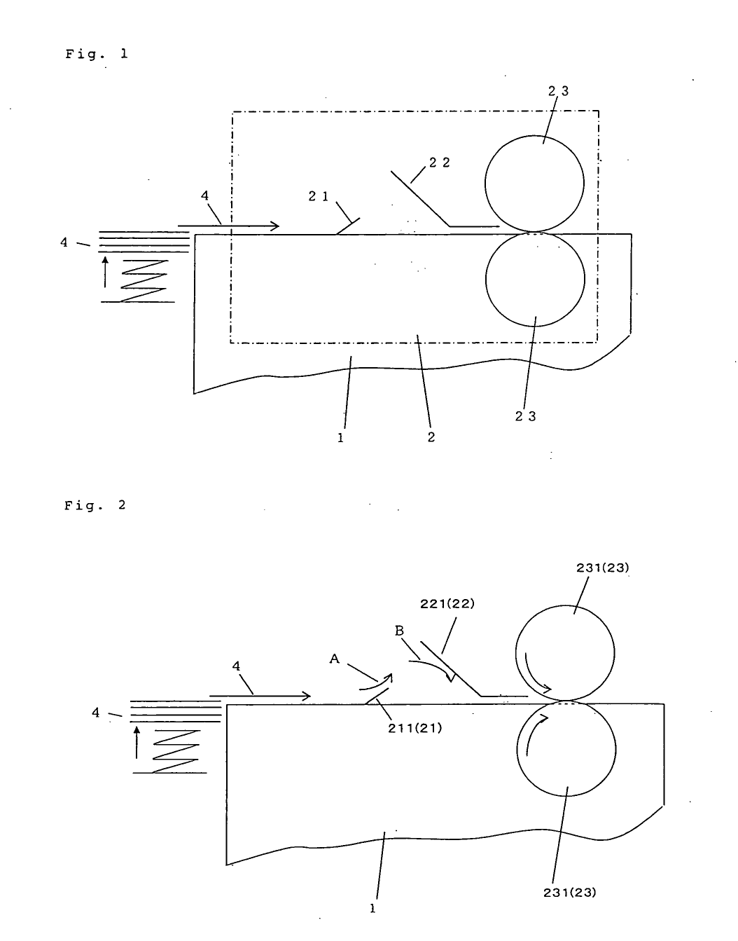

As shown in FIG. 1, a paper feeder in accordance with the first aspect of this invention is provided with novel means (2) having a function to align the direction of a sheet of cut paper (4) with the direction along which the cut paper (4) proceeds or to align the direction of the top edge of a sheet of cut paper (4) with a direction perpendicular to the direction along which the cut paper (4) proceeds along the top surface of a table (1). The novel means (2) is named “means (2) for aligning the direction of the top edge of cut paper”.

As shown in FIGS. 1, 2 and 3, the means (2) for aligning the direction of the top edge of cut paper can be comprised of “first means (21) for lifting the top edge of cut paper upward”, the means (21) having a function to lift the top edge of cut paper (4) upward and “second means (22) for revising the direction of the top edge of cut paper”, the means (22) having a function to revise the direction of the top edge of the currently proceeding cut paper (4) downward again, resultantly causing the proceeding cut paper (4) to be slackened and “third means (23) for adjusting the direction of the top edge of cut paper”, the means (23) actually being a set of rolls (231) having a first function to wait unmoving until a sheet of cut paper (4) that is a little slackened reaches and to align the direction of the top edge of the cut paper (4) with the direction of the rolls (231) at the instant when the top edge of the cut paper (4) reaches at the set of rolls (231) and a second function to start rotation to feed the sheet of cut paper (4) whose direction is aligned with the ordinary direction.

More practically, as shown in FIGS. 1, 2, and 3 as well, the means (21) having a function to lift the top edge of cut paper (4) upward can be embodied as “a plate member (211) upward inclining from the top surface of the table (1)”. The second means (22) for revising the direction of the top edge of cut paper, the means (22) having a function to revise the direction of the top edge of the currently proceeding cut paper (4) downward again, can be embodied as “a plate member (221) downward inclining toward the top surface of the table (1)”. As was described above, the third means (23) for adjusting the direction of the top edge of cut paper that actually is a set of rolls (231) is designed to wait unmoving until a sheet of cut paper (4) that is a little slackened reaches and to align the direction of the top edge of the cut paper (4) with the direction of the rolls (231) at the instant when the top edge of the cut paper (4) reaches at the set of rolls (231) and to start rotation to feed the sheet of cut paper (4) whose direction is aligned with the ordinary direction.

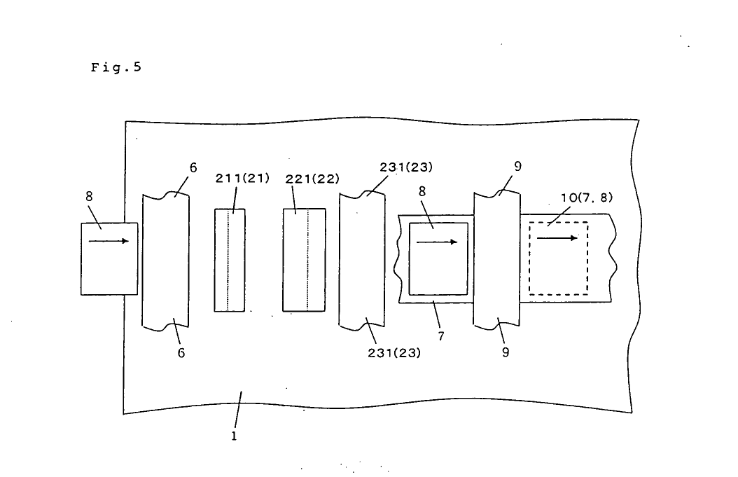

As shown in FIGS. 4 and 5, a laminating machine in accordance with the second aspect of this invention is provided with the paper feeder in accordance with the first aspect of this invention.

The advantageous result of this invention is replacement of the sophisticated automatic control system comprising a sensor to detect an extraordinary or oblique direction of the top edge of cut paper, an equipment for comparison of the detected extraordinary direction with a predetermined reference and a servomechanism working in response to the result of the comparison equipment to correct the extraordinary or oblique direction of the cut paper more specifically the top edge of cut paper by an equipment extremely simple in principle and structure, easy to handle and less expensive in the production cost, still having results virtually identical to the foregoing sophisticated automatic control system.

### BRIEF DESCRPTION OF THE DRWINGS

FIG. 1 is a conceptual side-view of a paper feeder in accordance with the first aspect of this invention

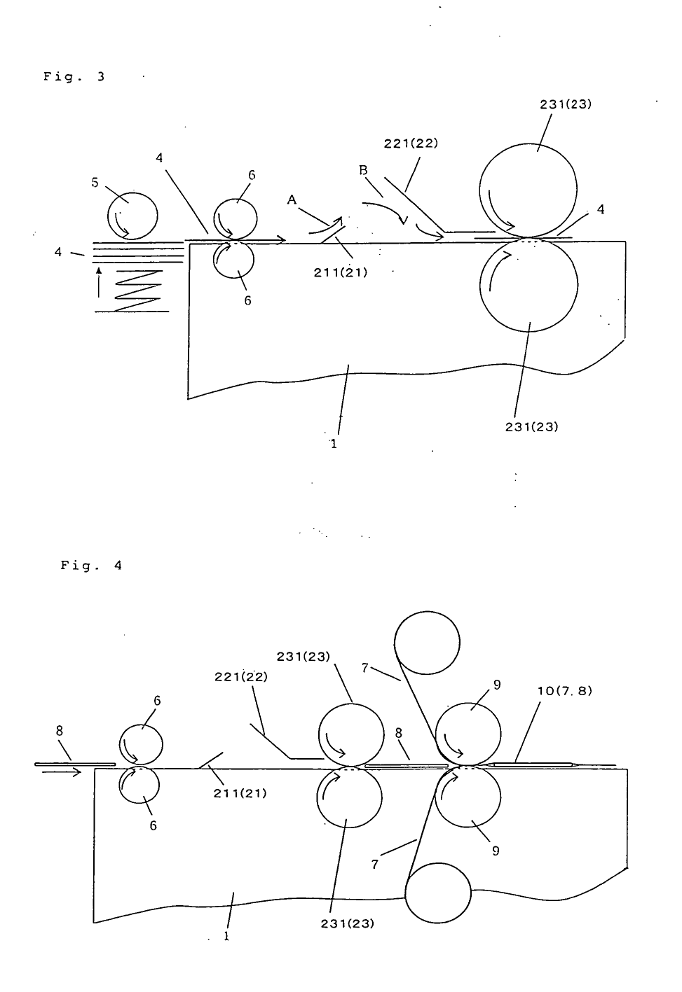

FIG. 2 is a conceptual side-view of a paper feeder in accordance with an embodiment of the first aspect of this invention

FIG. 3 is a conceptual side-view of a paper feeder in accordance with the other embodiment of the first aspect of this invention

FIG. 4 is a conceptual side-view of a laminating machine in accordance with this invention, and

FIG. 5 is a conceptual plan-view of a laminating machine in accordance with the second aspect of this invention

### BEST MODES IMPLEMENTING THIS INVENTION

Referring to the drawings, a paper feeder and a laminating machine in accordance with the best modes of this invention will be described below.

### First Embodiment

A bunch of cut paper (4) is kept at the side of a table (1). Each sheet of the cut paper (4) is fed one by one toward a driven set of rolls (6) that feeds the cut paper toward means (21) having a function to lift the top edge of cut paper (4) upward. Practically, the means (21) is embodied as a plate member (211) upward inclining from the top surface of the table (1). Then, the cut paper (4) is fed toward means (22) that that practically is a plate member (221) downward inclining toward the top surface of the table (1). The means (21) and the means (22) in combination have a function to slacken the cut paper. The cut paper that is slackened is then fed toward means (23) that practically is a set of rolls (231). The set of rolls (231) that waits unmoving until the cut paper that is slackened reaches has a function to align the direction of the top edge of the cut paper with the direction of the rolls (231). At this point of time, the rolls (231) start rotation to feed the cut paper whose direction is aligned with the ordinary direction toward the next step.

In this manner, the object of this invention is satisfied.

### Second Embodiment

Referring to FIGS. 4 and 5, a laminating machine in accordance with the second embodiment of this invention will be described below.

A sheet of cut paper having a shape of a quadrilateral (8) that will be sandwiched between a couple of plastic films (7) is fed towards a gap of a driven set of rolls (6) to be further fed toward means (21) practically a plate member (211) having a function to lift the top edge of cut paper (8) upward. Then, the cut paper (8) is fed toward means (22) having a function to cause the cut paper (8) to be slackened, the means (22) practically being a plate member (221) downward inclining toward the top surface of the table (1). The means (23) that practically is a set of rolls (231) is identical to the one of the first embodiment of this invention. It is needless to emphasize that the means (23) that practically is a set of rolls (231) has a function to align the direction of the top edge of the cut paper (8) with the direction of the set of rolls (231). A set of driven rolls (9) heats and presses a piled body of the cut paper (8) sandwiched between a couple of plastic films (7) to make a lamination (10) or a laminated body of the cut paper (8) and a couple of plastic films (7).

Various types of laminating machines are available in the prior art. In the second embodiment of this invention, however, a laminating machine having a function to sandwich a sheet of cut paper between a couple of plastic films is assumed. Since the cut paper usually has a shape of quadrilateral and since the cut paper is required to be placed at a specific location on the plastic films with a specific top, bottom and both side margins, the laminating machine requires a requirement identical to that for the paper feeder of this invention.

The foregoing description has clarified that this invention has successfully provided a paper feeder and a laminating machine that successfully satisfy the objects of this invention.

1. A paper feeder comprising:
a table (1) on which a sheet of cut paper (4) having a shape of a quadrilateral is fed, and
means (2) for aligning the direction of the top edge of said cut paper (4), said means (2) being placed on said table (1), and said means (2) having a function to align the direction of the top edge of said cut paper (4) with a direction perpendicular to the direction along which said cut paper (4) proceeds along the top surface of said table (1).

2. A paper feeder in accordance with claim 1, wherein:
said means (2) for aligning the direction of the top edge of said cut paper (4) further comprising:
means (21) for lifting the top edge of said cut paper upward, said means (21) having a function to lift the top edge of said cut paper (4) upward,
means (22) for revising the direction of said top edge of cut paper, said means (22) having a function to revise the direction of the top edge of said cut paper (4) downward again, and
means (23) for adjusting the direction of said top edge of cut paper, said means (23) being a set of rolls (231) that stays unmoving until the top edge of said cut paper reaches and start moving, when the top edge of said cut paper has reached.

3. A paper feeder in accordance with claim 2, wherein:
said means (21) for lifting the top edge of said cut paper upward, said means (21) having a function to lift the top edge of said cut paper (4) upward further comprising:
a plate member (211) upward inclining from the top surface of said table (1), said plate member (211) being arranged on the top of said table (1), and
said means (22) for revising the direction of the top edge of said cut paper (4) further comprising:
a plate member (221) downward inclining toward the top surface of the table (1), said plate means (221) being located at the immediate upstream of said means for adjusting the direction of the top edge of cut paper (23).

4. A laminating machine comprising:
a paper feeder in accordance with claim 1.

5. A laminating machine comprising:
a paper feeder in accordance with claim 2.

6. A laminating machine comprising:
a paper feeder in accordance with claim 3.
